(19) United States
(12) Patent Application Publication
(10) Pub. No.: US 2006/0026892 A1
(43) Pub. Date: Feb. 9, 2006

(54) Adjustable rig

(76) Inventor: Shigeyuki Nakamichi, Nishiwaki-City (JP)

Correspondence Address: David T. Bracken;The Law Office of David T. Bracken, 4839 Bond Avenue, Orange, CA, 92869, US

(21) Appl. No.: 10/914,765

(22) Filed: Aug. 9, 2004

(51) Int. Cl. A01K 91/04

(52) U.S. Cl. 43/44.85

(57) ABSTRACT

The present invention is an adjustable rig having a connector cord section connecting a rig device to the main fishing line, whereby when the main fishing line is substantially vertical with the terminal device at the lowest end, the rig device is spaced apart from the terminal device by a desired distance and is easily moved up and down the main fishing line when finger pressure of a user is applied to push directly against a top or bottom portion of the connector cord section in a direction generally axial to an axis of the main fishing line.

### BACKGROUND OF THE INVENTION

The present invention relates to fishing tackle, especially to fishing leaders with adjustable rigs.

A fishing line may have more than one hook-bearing device for catching fish. These hook bearing devices can be bare hooks, bait bearing hooks, or lures. With multiple hook-bearing devices on the same main fishing line, a user may improve the chances of catching one or more fish in the same cast. A “rig” is a hook bearing device with a connection to the main fishing line.

In an very effective form of a fishing line with multiple rigs, an adjustable rig comprises a hook or lure attached somewhere above a hook or lure that is tied or attached to the terminal end of a main fishing line. The adjustable rig may optionally be connected to the main line via a short piece of fishing line of its own. However, the most important feature of the adjustable rig is the ability to be moved up and down the length of the main line above a hook or lure that is tied or attached to the terminal end of a main fishing line. The main line is at one end part to the terminal hook or lure and adjustable rigs and at the other end to a reel of a user.

In operation, a rig must stay securely tied to a fixed position on the main line. The fixed position maintains the user's desired separation between terminal devices (such as hooks and lures) while trolling or dangling the main line in a body of water to attract fish. Some rigs, such as the Carolina rig, require several knots be tied in the fishing line to position a sinker or a rig at a desired distance above of a terminal device. Each knot weakens the line. When the distance between the rig at the end of the main line and any other rig is changed, the main line must be cut and all knots must be re-tied. This wastes critical time at the fishing site when a particularly good strike is in progress. A user may need to reposition the rigs with respect to each other quickly to take advantage of the benefit of better rig spacing.

U.S. Pat. No. 315,967 shows that two tri-hooks can be separated along a rigid support by tying knots around the main line and an upper tri-hook. No change in hook separation is possible without cutting thread fixing the hook shafts to a main shaft.

U.S. Pat. No. 6,006,468 discloses a hook located on a terminal end and another hook farther up a main line. An upper end of the shaft of the upper hook is fixed to the main line by a crimp connector and then loosely surrounded with flexible loops in a figure eight pattern. The flexible loops do not tighten about the shaft and main line at any time. The flexible loops only align the shaft so that a strike on the upper hook does not cause it to be dragged out of alignment with the lower hook. The flexible loops have no function other than to loosely align the upper hook in a manner reminiscent of the arrangement shown in U.S. Pat. No. 315,967.

U.S. Pat. No. 5,881,490 discloses a leader wire made from a stainless steel cable and includes a loop at one end and a swivel at the other. A terminal hook is attached to a loop at the end of the leader. An upper hook is attached to the leader wire and can be moved along the length of the leader. A length of thin copper wire is twisted around the leader at a position between the second hook and the swivel and is movable along its length. The copper wire can be held in place, however, by a small sleeve that passes over the same. The wire is utilized to hold the mouth of the bait fish closed and to hold the bait fish in place by wrapping the wire around the same.

U.S. Pat. No. 2,814,903 discloses dual rubber bands used to attach a float to a fishing line. The float can be moved up and down the main line with respect a terminal device, a single hook. The rubber bands cannot secure the float in place on the main line under moderate motion across the top of the water.

U.S. Pat. No. 6,072,386 shows that a float can be secured to a main line under moderate severe trolling conditions using a labyrinth connection to a main line. Although the adaptation for securing the float to the main line requires major structure changes to the prior art float, the float of the '386 patent is adjustable along the length of the main line.

A prior art device for providing an adjustable rig is shown on Page 22 of a catalog titled “Owner®/Perfection in Hooks/Cutting Point Hooks/2005/C'ultiva Lures” (published as a promotional catalog by Owner American Corporation in 2004, 3199-B Airport Loop Drive, Costa Mesa, Calif. 92626). The device shown is a fairly sophisticated improvement over the use of rigid crimp means, in that a polymer sleeve encloses the main line passage through the snell of the upper hook. The polymer sleeve is a “flexible plastic” slider wrapped tightly with flexible, small diameter monofilament. This construction is essentially a crimp connector that allows the user to pull the upper hook up and down along the length of the main line. However, the upper hook is subject being pulled down to the terminal hook when a fish is set on the upper hook and the fish is reeled in.

Only a few prior art devices have been absolutely secure in holding the location of an adjustable rig on a main line. However, these devices are adjustable only by taking time consuming action that weakens the main line. Strong crimp pieces can connect an adjustable rig to a main line, but those pieces can cut or weaken the main line. No other absolutely secure connections are known. Such crimp pieces often add undue weight to the overall end part of the main line, causing more sinking that necessary.

There is a need for a structure and method for a rig that is easily adjustable along the length of the main line. The prior art uses separate knots, crimp connections or similar structures to provide for adjustable rigs.

### SUMMARY OF THE INVENTION

The present invention is a slideable rig that fixes firmly to a main line in operation but is movable with thumb and forefinger movement up and down the length of the main line. When the hook of the adjustable rig is pulled, the invention rig tightens about the main line. As the tension on the hook increases, the tension of the rig on the main line increases proportionally.

The invention rig comprises a rig-to-main line connector of strong, multifilament cord. A preferred material of the cord is Kevlar® (polyparaphenylene terephthalamide or a polyamide), Nomex® (dimethyl acetamide), ultra-high molecular weight polyethylene fiber (Spectra™) or equivalent material, most preferably in a “soft cord” form. The following tables show typical Kevlar® thread:

| | Approximate Yards/ | |
|---|---|---|
| | Pound Minimum | Tensile Strength |
| Filament Kevlar Size | | |
| A | 20,000 | 8.0 lbs. |
| B | 10,000 | 16.0 |
| E | 6,700 | 25.0 |
| F | 5,000 | 35.0 |
| FF | 3,350 | 50.0 |
| 3 Cord | 2,100 | 80.0 |
| 5 Cord | 1,050 | 150.0 |
| Spun Kevlar Size | | |
| T-35 | 12,000 | 6.0 lbs. |
| T-50 | 8,000 | 8.5 |
| T-70 | 6,000 | 12.0 |
| T-90 | 4,750 | 16.0 |
| T-105 | 4,000 | 19.0 |
| T-135 | 3,500 | 22.0 |

In a first step, the cord is wrapped and tied around the main line, leaving two free ends. In a second step these two free ends are intertwined and tied to the snell of a hook (or its equivalent). The resulting cord arrangement is surprisingly movable up and down the main line, while a simple tug on the connected hook causes the cord to frictionally embrace the main line with intense force. As tension on the connected hook increases, the embracing force of the cord around the main line increases proportionally. It is preferred that the main fishing line be polymer monofilament, but the invention is adapted to be used with polymer multifilament line and, to a lesser degree, fibrous multifilament line. Such monofilament is relatively impressionable by the individual threads of the invention connector cord. In addition, typical fishing environments include many severe conditions for a connector in an adjustable rig, such as submersion in sediment and organics-filled water, subsequent drying, abrasion, and exposure to the serrations of fish teeth. The invention connector requires a superior cord material with strength and surface frictional properties such as Kevlar® so that the connector cord essentially “squeezes” into the surface of the main fishing line.

A primary object of the invention is to provide an adjustable fishing rig that can be moved along a main fishing line without requiring the untying of knots and the tying of new knots.

A further object is to provide an adjustable rig that has a rig-to-main line connection with almost negligible additional weight.

Another object is to provide that rig-to-main line connection with almost negligible additional drag as compared with a hook or lure itself.

Other objects and advantages of the rigs incorporating this invention will be found in the specification and claims and the scope of the invention will be set forth in the claims.

### BRIEF DESCRIPTION OF THE DRAWINGS

FIG. 1 is a side view of one form of the invention adjustable rig.

FIG. 2 shows a first action in forming the connector section.

FIG. 3 shows a second action in forming the connector section.

FIG. 4 shows a third action in forming the connector section.

FIG. 5 shows a first action in forming an alternate embodiment of the connector section.

### DETAILED DESCRIPTION OF THE INVENTION

The invention is now discussed with reference to the figures.

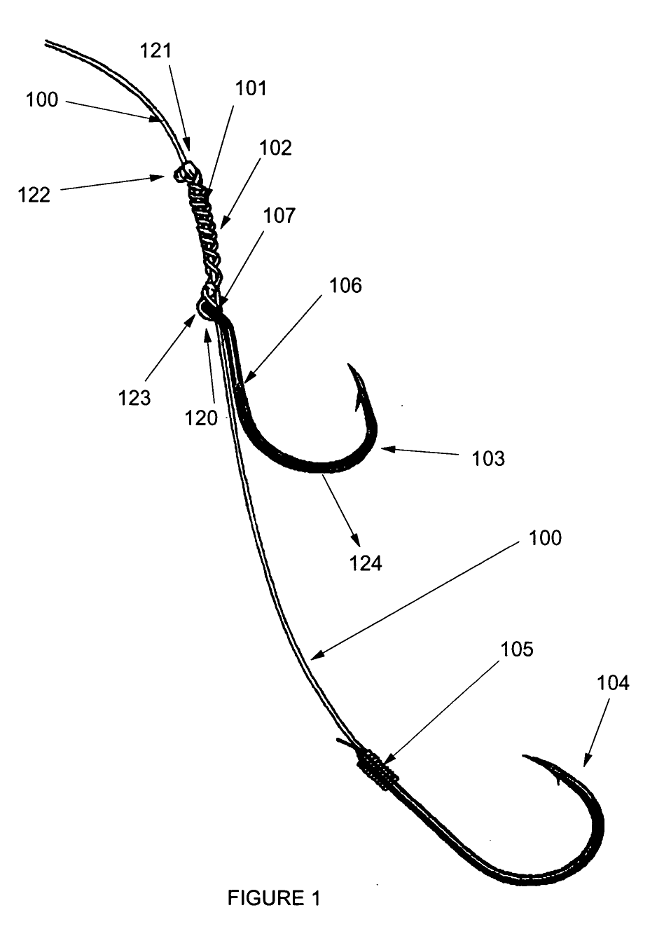

FIG. 1 shows a side view of one embodiment of the invention. A main fishing line 100 is engaged by connector section 102 comprising a wrapping or connector cord 101. Connector section 102 connects hook 103 via snell 107 to the main fishing line 100. The adjustable rig comprising connector section 102 and hook 103 can be easily moved in up direction 120 and down direction 121 along main fishing line 100 when finger pressure is applied directly to knot 110 in a direction generally axial to the axis of line 100. To move the adjustable rig in the up direction 120, finger pressure is applied to the lower portion 123 of connector section 102. To move the adjustable rig in the down direction 121, finger pressure is applied to the upper portion 122 of connector section 102. A terminal hook 104 is shown tied to the terminal end 105 of line 100. The hook 103 easily slides away from or toward hook 104 by use of the invention connector section 102. However, is tension in direction 124 is applied to hook 103, the portion of the connector section 102 surrounding line 100 frictionally tightens around line 100 and the adjustable rig maintains its position on line 100, even sustaining that position through a strike and reeling in a heavy fish.

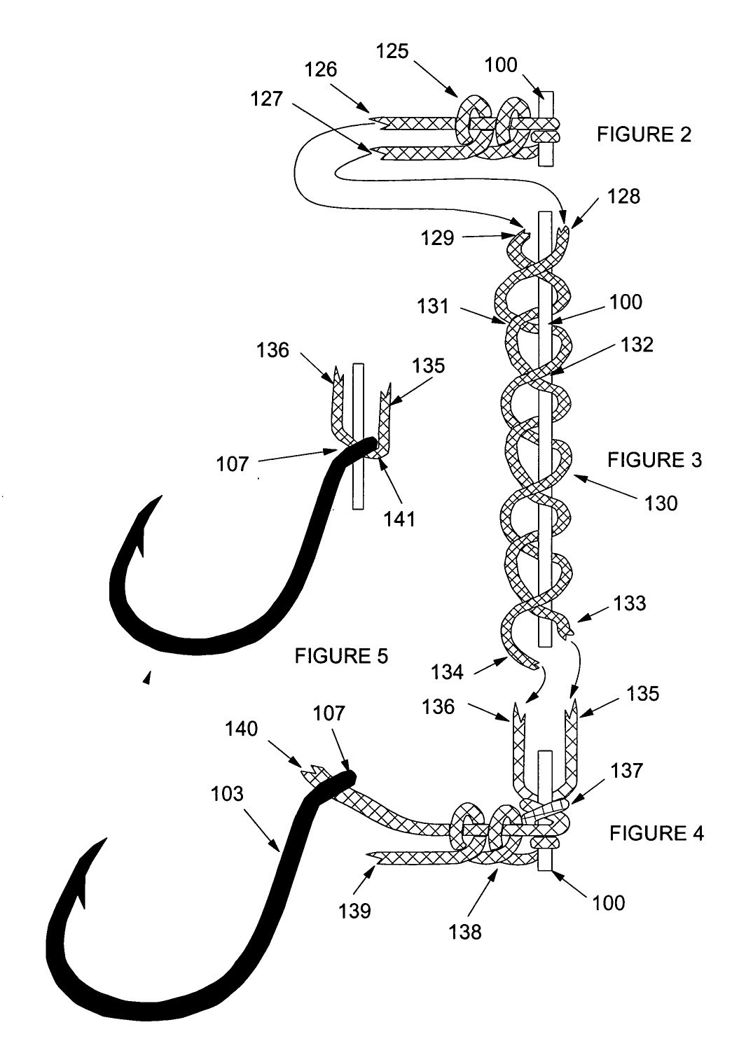

FIG. 2 shows a first action in applying the connector cord to a main fishing line 100 to form connector section 102. In a preferred embodiment, the cord is a multifilament wrapping cord having a diameter of about the same or less than that of the main fishing line 100. In another preferred embodiment, the wrapping cord has five or more filaments, and more preferably ten or more filaments. The cord in FIG. 2 is shown being tied in a knot 125 around line 100, generally defining a generally defining a half hitch, although other well known knots can be used, such as the thumb or overhand knot, clove hitch, rolling hitch, or buntline hitch. Knot 125 is tied loosely enough so that the cord can be easily moved up and down line 100 when finger pressure is applied directly to knot 125 in a direction generally axial to the axis of line 100. However, knot 125 is tied tightly enough around line 100 to achieve the objects of the invention. Free ends 126 and 127 extend sufficiently to perform the actions of FIGS. 3 and 4. FIG. 3 shows a second action in applying the connector cord to a main fishing line 100. Free ends 128 and 129 connect respectively to free ends 126 and 127 (FIG. 2). Knot 125 (FIG. 2) forms a secure locus from which individual figure-eight loops 131 and 132 are drawn and formed around line 100 to form loop section 130. Forming each loop 131 or 132 is done (or later tightened) preferably to minimize cord length needed for each such loop. Minimizing cord length in each loop 111 improves the gripping effect of cord 101 around line 100 when the connected hook 103 is pulled with substantial tension in direction 124 (FIG. 1). Again referring to FIG. 3, at least four loops 131 and 132 are formed to complete loop section 130, although it is more preferable that six or more loops comprise loop section 130 to provide additional gripping force around the main fishing line 100. After loop section 130 is formed, free ends 133 and 134 extend to be used in the action shown in FIG. 4.

FIG. 4 shows a third action in applying the invention connector cord 101 to a main fishing line 100. Free ends 135 and 136 connect respectively to free ends 133 and 134 (FIG. 3). Free ends 135 and 136 are extended to optionally form a first overhand knot 137, which forms a secure locus from which half hitch knot 138 can be made. Knot 138 generally defines a half hitch, although other well known knots can be used, such as the thumb or overhand knot, clove hitch, rolling hitch, or buntline hitch. Knot 138 is tied loosely enough so that cord 101 can be easily moved up and down line 100 when finger pressure is applied directly to knot 110 in a direction generally axial to the axis of line 100. However, knot 138 is tied tightly enough around line 100 to achieve the objects of the invention. Free end 140 extends through snell 107 of hook 103, wherewith free end 139 is used to tie a securing knot for hook 103 as a rig device for the adjustable rig.

FIG. 5 shows a first action of an alternate embodiment (as shown in FIG. 1) in applying the invention connector cord 101 to a main fishing line 100. A length of connector or wrapping cord and main fishing line 100 are threaded through the snell 107 leaving free ends 135 and 136 and forming loop 141 as a secure locus for then upwardly forming the loop section shown in FIG. 3 and then taking a final action to form the knot 125 of FIG. 2. In effect, the embodiment of the invention started in FIG. 5 is formed in reverse steps of the preceding embodiment starting at FIG. 2 and ending at FIG. 4.

The main fishing line 100 may also be multifilament and formed from steel strands. Fishing leaders may of 3 or more strands of steel wire (other metal) are well known in the fishing art. The cord material of connector cord 101 is adapted to obtain the objects of the invention when the main fishing line is a metal leader. In this embodiment, the cord material of connector cord 101 is treated or formed in a manner so that the figure eight section of the connector cord 101 will not substantially move in direction 124 (FIG. 1) relative to line 100 when tension is applied to hook 103 in direction 124. The treatment and composition of the cord material to obtain these objects includes surface treatment with a natural or synthetic rubber or incorporation of such into the cord material. Surface treatment also includes adhesives and pressure activated adhesives.

The above design options will sometimes present the skilled designer with considerable and wide ranges from which to choose appropriate apparatus and method modifications for the above examples. However, the objects of the present invention will still be obtained by that skilled designer applying such design options in an appropriate manner.

I claim:

1. An fishing apparatus comprising:
(a) a main fishing line comprising a terminal end tied to a terminal device and a user end;
(b) an adjustable rig means having a connector cord section connecting a rig device to the main fishing line, whereby when the main fishing line is substantially vertical with the terminal device at the lowest end, the rig device is spaced apart from the terminal device by a desired distance and is easily moved up and down the main fishing line when finger pressure of a user is applied to push directly against a top or bottom portion of the connector cord section in a direction generally axial to an axis of the main fishing line; and
(c) the connector cord section comprises a multifilament cord wrapped around the main fishing line.

2. The apparatus of claim 1 wherein the main fishing line at a part upward from of the terminal end is a monofilament or multifilament line formed from polymer or steel.

3. The apparatus of claim 2 wherein the connector cord section consists a cord material of polyparaphenylene terephthalamide fiber, polyamide fiber, dimethyl acetamide fiber, or ultra-high molecular weight polyethylene fiber.

4. The apparatus of claim 1 wherein the connector cord section is adapted to frictionally resist displacement on the main fishing line when tension is applied to the rig device.

5. The apparatus of claim 4 wherein the connector cord section comprises two wrapping cords generally forming four or more figure eight patterns around the main fishing line.

6. The apparatus of claim 4 wherein the connector cord section comprises two wrapping cords generally forming six or more figure eight patterns around the main fishing line.

7. The apparatus of claim 6 wherein the wrapping cords have five or more filaments.

8. The apparatus of claim 6 wherein a diameter of the wrapping cords is about the same or less than that of the main fishing line.

9. The apparatus of claim 6 wherein an upper knot is tied with the wrapping cords at a point distal to the terminal device.

10. The apparatus of claim 9 wherein a lower knot is tied with the wrapping cords at a point proximal to the terminal device.

11. The apparatus of claim 10 wherein the wrapping cords extend from the lower knot and are adapted in linking means to secure the rig device to the connector cord section.

12. The apparatus of claim 10 wherein the rig device comprises a snell or loop through which linking means pass.

13. The apparatus of claim 12 wherein the main fishing line passes though the snell or loop of the rig device.

14. 1. A method for forming an adjustable rig comprising:
(a) tying to a terminal end of a main fishing line a terminal device; and
(b) forming a connector cord section by:
(i) tying a first knot to the main fishing line with a wrapping cord, leaving two free ends of the wrapping cord;
(ii) wrapping in a direction toward the terminal device the two free ends of the wrapping cord around the main fishing line in four or more figure eight patterns, leaving two free ends of the wrapping cord;
(iii) tying a second knot to the main fishing line, leaving two free ends of the wrapping cord; and
(iv) using the additional wrapping cord to secure a rig device to the connector cord section.

15. The method of claim 14 wherein when the main fishing line is substantially vertical with the terminal device at the lowest end, the rig device is spaced apart from the terminal device by a desired distance and is easily moved up and down the main fishing line when finger pressure of a user is applied to push directly against a top or bottom portion of the connector cord section in a direction generally axial to an axis of the main fishing line.

16. The method of claim 14 wherein the rig device is pulled in a direction generally axial to an axis of the main fishing line causing a figure eight section of step (b)(ii) to frictionally constrict around the main fishing line, substantially preventing the connector cord section from being moved up or down the main fishing line.
